(19) United States
(12) Patent Application Publication
(10) Pub. No.: US 2023/0415084 A1
(43) Pub. Date: Dec. 28, 2023

(54) BLACK AIR FILTER OIL COMPOSITION

(71) Applicant: K&N Engineering, Inc., Riverside, CA (US)

(72) Inventor: Steve Williams, Cherry Valley, CA (US)

(73) Assignee: K&N Engineering, Inc., Riverside, CA (US)

(21) Appl. No.: 18/367,240

(22) Filed: Sep. 12, 2023

Related U.S. Application Data
(63) Continuation of application No. 16/663,227, filed on Oct. 24, 2019, now abandoned.
Application No. 16/663,227 is a continuation of application No. 14/974,092, filed on Dec. 18, 2015, now Pat. No. 10,434,466.
(60) Provisional application No. 62/751,104, filed on Oct. 26, 2018.

(51) Int. Cl. B01D 46/00; C08L 23/08; C08L 91/00; B60H 3/06

(52) U.S. Cl. CPC B01D 46/0035; C08L 23/0823; C08L 91/00; B60H 3/06; B05D 1/025

(57) ABSTRACT

An air filter oil composition is provided for enhancing airflow and filtration of air passing through an air filter. The composition includes a first portion comprising paraffinic oil, a second portion comprising polyalphaolefin (PAO), and a third portion comprising black dye. Applying the air filter oil composition to a cotton air filter material causes tackiness throughout the air filter material, thereby enhancing airflow and filtration of air passing through the air filter. The composition generally is substantially non-reactive, has an excellent oxidation stability, possesses good thermal stability, and retains a suitable viscosity at normal operating temperatures of an automobile engine. In an embodiment, the composition comprises 96.74% paraffinic oil by volume, 3.20% PAO by volume, and 0.06% black dye by volume. A viscosity of the composition at 100 degrees-C. ranges between substantially 7.2 and 7.6 centistokes (cSTs).

### PRIORITY

This application claims the benefit of and priority to U.S. patent application Ser. No. 16/663,227, filed on Oct. 24, 2019 and U.S. Provisional Application, entitled “Black Air Filter Oil Composition,” filed on Oct. 26, 2018 having application Ser. No. 62/751,104 and U.S. patent application Ser. No. 14/974,092 filed on Dec. 18, 2015, issued as U.S. Pat. No. 10,434,466.

### FIELD

Embodiments of the present disclosure generally relate to the field of air filters. More specifically, embodiments of the disclosure relate to an air filter oil formulation for causing tackiness throughout the air filter material to enhance airflow and filtration of air passing through the air filter.

### BACKGROUND

An air filter designed to remove particulate is generally a device composed of fibrous materials. These fibrous materials may remove solid particulates such as dust, pollen, mold, and bacteria from the air. Air filters are used in applications where air quality is important, notably in building ventilation systems and in automobile engines.

Air filters may be used in automobiles, trucks, tractors, locomotives and other vehicles that use internal combustion engines. Air filters may be used with gasoline engines, diesel engines, or other engines that run on fossil fuels or other combustible substances. Air filters may be used with engines in which combustion is intermittent, such as four-stroke and two-stroke piston engines, as well as other types of engines that take in air so as to burn a combustible substance. For example, air filters may be used with some gas turbines. Filters may also be used with air compressors or in other devices that take in air.

Filters may be made from pleated paper, foam, cotton, spun fiberglass, or other known filter materials. Generally, the air intakes of internal combustion engines and compressors tend to use paper, foam, or cotton filters. Some filters use an oil bath. Air filters for internal combustion engines prevent abrasive particulate matter from entering the engine's cylinders, where it would cause mechanical wear and oil contamination.

A drawback to paper air filters is that they must be thick, or the fibers must be tightly compressed and dense, which makes paper filters restrictive to air flow. Moreover, as a paper filter becomes more and more clogged with contaminants, the pressure inside the filter drops while the atmospheric air pressure outside the filter remains the same. When the pressure differential becomes too great, due to clogging, contaminants may be pulled through the restricted air filter into the engine. Thus, the performance of a paper air filter (i.e. air flow through the filter and its ability to protect the engine) decreases over the course of the filter's service life.

As will be appreciated by those skilled in the art, one way to reduce the clogging tendency of an air filter is by using a filter material having larger openings between the various fibers comprising the filter material. Of course, a more porous filter material may allow smaller particulate matter to pass through the air filter material, unless the fibers comprising the filter material are sufficiently tacky to cause smaller contaminants to cling to the fibers rather than passing through the air filter. Various oils are known to attract airborne contaminants. However, an oil suitable for use with an air filter must be relatively non-reactive, have an excellent oxidation stability, possess good thermal stability, and retain suitable viscosity at high operating temperatures typical of automobile engines. What is needed, therefore, is a suitably formulated filter oil composition for causing tackiness throughout the air filter material so as to enhance airflow and filtration of intake air to an automobile engine.

### SUMMARY

An air filter oil composition and methods are provided for enhancing airflow and filtration of air passing through an air filter. The composition includes a first portion comprising paraffinic oil, a second portion comprising polyalphaolefin (PAO), and a third portion comprising black dye. Applying the air filter oil composition to a cotton air filter material causes tackiness throughout the air filter material, thereby enhancing airflow and filtration of air passing through the air filter. The composition generally is substantially non-reactive, has an excellent oxidation stability, possesses good thermal stability, and retains a suitable viscosity at normal operating temperatures of an automobile engine. In an embodiment, the composition comprises 96.74% paraffinic oil by volume, 3.20% PAO by volume, and 0.06% black dye by volume. A viscosity of the composition at 100 degrees-C. ranges between substantially 7.2 and 7.6 centistokes (cSTs).

In an exemplary embodiment, an air filter oil composition for causing tackiness throughout an air filter material to enhance airflow and filtration of air flowing through the air filter material comprises: a first portion comprising paraffinic oil by volume of the composition; a second portion comprising polyalphaolefin by volume of the composition; and a third portion comprising black dye by volume of the composition.

In another exemplary embodiment, the composition is substantially non-reactive, has an excellent oxidation stability, possesses good thermal stability, and retains a suitable viscosity within a temperature range typical of an operating automobile engine. In another exemplary embodiment, the composition has a viscosity at 100 degrees-C. ranging between substantially 7.2 and 7.6 centistokes (cSTs).

In another exemplary embodiment, the composition comprises paraffinic oil ranging between 95.00% and 98.00% by volume, polyalphaolefin ranging between 1.00% and 4.00% by volume, and black dye ranging between 0.04% and 1.00% by volume. In another exemplary embodiment, the composition comprises 96.74% paraffinic oil by volume, 3.20% polyalphaolefin by volume, and 0.06% black dye by volume.

In another exemplary embodiment, the composition is configured to be applied to the air filter material by way of an aerosol spray. In another exemplary embodiment, the composition is configured to be applied to the air filter material by way of a squeeze bottle.

In an exemplary embodiment, a method for an air filter oil composition for enhancing filtration of air flowing through an air filter material comprises: providing a first portion of paraffinic oil and a second portion of polyalphaolefin; mixing the first portion with the second portion to form a mixture; applying a third portion comprising black dye to the mixture to form a composition; and configuring the composition to be applied to the air filter material.

In another exemplary embodiment, mixing includes providing the second portion such that the composition comprises polyalphaolefin ranging between 1.00% and 4.00% by volume. In another exemplary embodiment, applying includes providing the third portion to the mixture such that the composition comprises black dye ranging between 0.04% and 1.00% by volume. In another exemplary embodiment, applying includes providing the third portion to the mixture such that the composition comprises 96.74% paraffinic oil by volume, 3.20% polyalphaolefin by volume, and 0.06% black dye by volume.

In another exemplary embodiment, configuring includes configuring the composition to be applied to the air filter material by way of an aerosol spray. In another exemplary embodiment, configuring includes configuring the composition to be applied to the air filter material by way of a squeeze bottle.

In an exemplary embodiment, a method for enhanced filtration of an airstream comprises: configuring an air filter comprising a filter material that exhibits minimal resistance to the airstream; formulating an air filter composition that causes tackiness throughout the filter material; applying the air filter composition to the filter material; and causing the airstream to flow through the filter material.

In another exemplary embodiment, formulating comprises: providing a first portion of paraffinic oil and a second portion of polyalphaolefin; mixing the first portion with the second portion to form a mixture; applying a third portion comprising black dye to the mixture to form a composition; and configuring the composition to be applied to the air filter material. In another exemplary embodiment, applying includes providing the third portion to the mixture such that the composition comprises 96.74% paraffinic oil by volume, 3.20% polyalphaolefin by volume, and 0.06% black dye by volume.

In another exemplary embodiment, configuring includes sandwiching multiple layers of cotton gauze between two screens to form the filter material. In another exemplary embodiment, applying includes using an aerosol spray to apply the air filter composition to the filter material. In another exemplary embodiment, applying includes using a squeeze bottle to apply the air filter composition to the filter material. In another exemplary embodiment, causing comprises positioning the air filter within a ventilation system which circulates air within an enclosed space.

### BRIEF DESCRIPTION OF THE DRAWINGS

The drawings refer to embodiments of the present disclosure in which:

FIG. 1 illustrates a perspective ghost-view of an exemplary use environment comprising a ventilation system of a vehicle that includes a cabin air filter which may be treated with a filter oil composition causing tackiness throughout the air filter medium so as to enhance airflow and filtration of air passing through the cabin air filter;

FIG. 2 illustrates a perspective ghost-view of an exemplary embodiment of a ventilation system comprising a cabin air filter which may be treated with a filter oil composition causing tackiness throughout the air filter medium so as to enhance airflow and filtration of air passing through the cabin air filter;

FIG. 3 illustrates an exemplary embodiment of a cabin air filter that may be treated with a filter oil composition causing tackiness throughout the air filter medium so as to enhance airflow and filtration of air passing through the cabin air filter; and

FIG. 4 illustrates an exemplary embodiment of a cabin air filter that may be treated with a filter oil composition causing tackiness throughout the air filter medium so as to enhance airflow and filtration of air passing through the cabin air filter.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first portion,” may be made. However, the specific numeric reference should not be interpreted as a literal sequential order but rather interpreted that the “first portion” is different than a “second portion.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, conventional air filters are restrictive to air flow and prone to clogging as more and more contaminants are captured. One way to reduce the clogging tendency of an air filter is by using a filter material having larger openings between the various fibers comprising the filter material, such as one or more layers of cotton. A porous filter material may allow passage of smaller particulate matter unless the fibers comprising the filter material are sufficiently tacky to cause smaller contaminants to cling to the fibers rather than passing through the air filter. Various oils are known to attract airborne contaminants. Embodiments of the present disclosure provide an air filter oil formulation for causing tackiness throughout air filter materials to enhance airflow and filtration of air passing through air filters. The embodiments disclosed herein provide a filter oil formulation that is relatively non-reactive, has an excellent oxidation stability, possesses good thermal stability, and retains suitable viscosity at high operating temperatures typical of automobile engines.

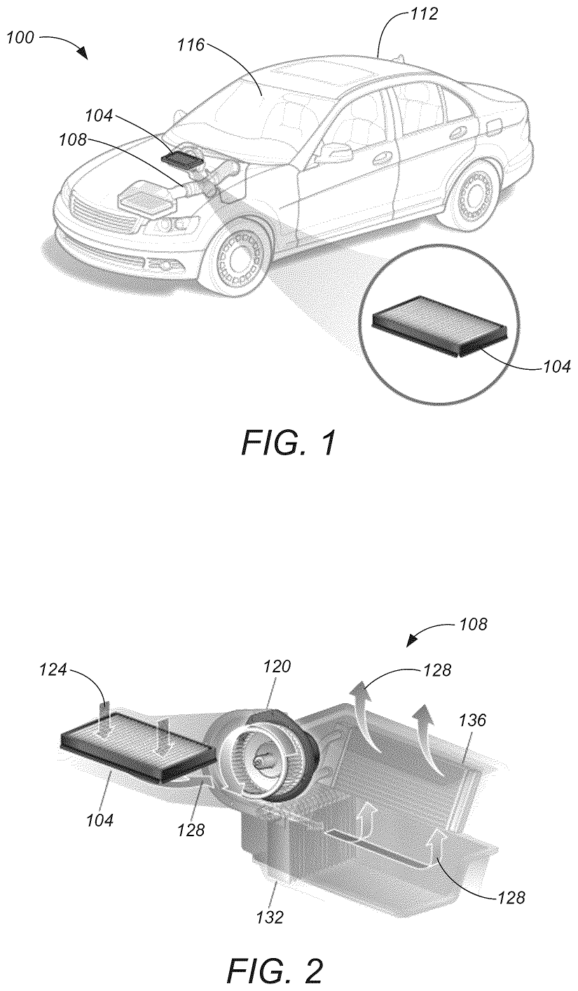

FIG. 1 illustrates an exemplary use environment 100 wherein a cabin air filter 104 is incorporated into a ventilation system 108 of a vehicle 112 so as to clean outside air drawn through the air filter 104 into a passenger compartment 116. It is contemplated that the cabin air filter 104 may be advantageously treated with a filter oil composition that causes tackiness throughout the air filter medium, thereby enhancing airflow and filtration of air passing through the filter 104. As shown in FIG. 2, the ventilation system 108 generally comprises a fan 120 configured to draw an outside air stream 124 through the air filter 104 whereby airborne molecular contaminants, volatile organic compounds, and other particle contaminants are removed from the air stream. Particle contaminants removed from the outside air stream 124 are entrapped in the air filter 104. The fan 120 then pushes a clean air stream 128 into an air conditioning system 132 or a heater core 136 and then into the passenger compartment 116.

It will be appreciated that in some embodiments, the air stream 124 may comprise air drawn from within the passenger compartment 116 rather than outside air. For example, a driver or a passenger may switch the ventilation system 108 to circulate air within the passenger compartment 116, thereby preventing outside air from entering passenger compartment 116. It should be understood, therefore, that in some embodiments the air filter 104 may be implemented so as to remove airborne molecular contaminants, volatile organic compounds, and other particle contaminants from interior air within the passenger compartment 116 being circulated through the ventilation system 108.

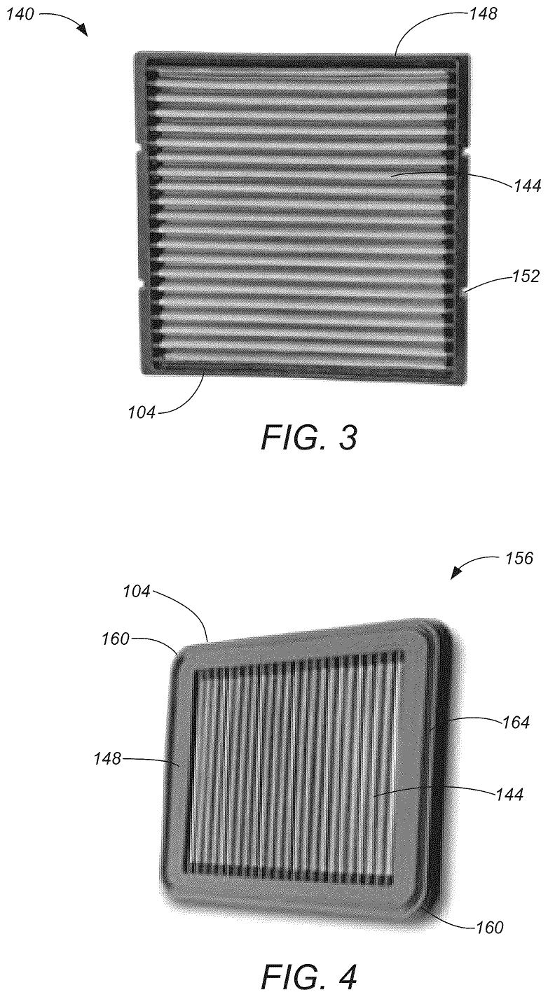

FIG. 3 illustrates an exemplary embodiment 140 of a cabin air filter 104 that may be treated with a filter oil composition that causes tackiness throughout the air filter medium so as to enhance airflow and filtration of air passing through the cabin air filter 104. The cabin air filter 104 generally comprises a filter medium 144 within a supportive frame 148. The supportive frame 148 is configured to orient the cabin air filter 104 within the ventilation system 108 such that the air stream 124 is directed through the filter medium 144. As such, the supportive frame 148 comprises a shape and size suitable for supporting the cabin air filter 104 within the ventilation system 108. It will be appreciated that the shape and size of the supportive frame 148 will vary depending upon the make and model of the vehicle 112 for which the filter 104 is intended to be used.

The supportive frame 148 may comprise various fastening structures suitably configured for securing the cabin air filter 104 within a particular ventilation system 108. To this end, in the embodiment illustrated in FIG. 3, the supportive frame 148 comprises a plurality of notches 152 configured to interface with protrusions within the ventilation system 108 of the vehicle 112. In another exemplary embodiment 156, illustrated in FIG. 4, the supportive frame 148 comprises rounded corners 160 and a ridge 164 configured to orient the cabin air filter 104 within the ventilation system 108 of a particular make and model of automobile. Further, the supportive frame 148 illustrated in FIG. 4 has a different shape than the shape of the supportive frame illustrated in FIG. 3. It should be understood, therefore, that the various structures and shapes incorporated into the supportive frame 148, and thus the cabin air filter 104 as a whole, will vary depending upon the make and model of the vehicle 112 for which the cabin air filter 104 is intended to be used without detracting from the spirit and scope of the present disclosure.

It will be appreciated that the filter medium 144 generally is retained within the supportive frame 148. It is contemplated that any of a variety of fasteners may be used to retain the filter medium 144 within the supportive frame 148. In some embodiments, the supportive frame 148 may be molded to a wire support of the filter medium 144. In some embodiments, the supportive frame 148 may comprise a crimped portion that folds onto and retains the wire support and the filter medium 144 of the cabin air filter 104. It will be appreciated that by those skilled in the art that fastening the filter medium 144 to the supportive frame 148 renders the filter medium 144 irremovable from the supportive frame 148.

It is contemplated that a user of the cabin air filter 104 may periodically clean the filter medium 144 rather than replacing the cabin air filter 104, as is typically done with conventional cabin air filter systems. It is envisioned that the cabin air filter 104 may be removed from the ventilation system 108, the ventilation system 108 cleaned of any debris trapped therein, and then a water hose used to flush contaminants from the filter medium 144, thereby leaving the filter clean and ready for reuse. Wherein the filter medium 144 has be previously treated with a filter oil composition, a solvent may be used to remove the oil from the filter medium 144. Once the filter medium 144 is completely dry, a suitably formulated filter oil composition may be uniformly applied and allowed to wick into the filter medium 144. The filter oil composition may be applied to the filter medium by way of an aerosol spray or a squeeze bottle, as desired. Various other cleaning methods will be apparent to those skilled in the art without deviating from the spirit and scope of the present disclosure.

In some embodiments, the filter medium 144 comprises 4 to 6 layers of cotton gauze sandwiched between two epoxy-coated aluminum wire screens. The cotton is advantageously treated with the above-mentioned suitably formulated filter oil composition for causing tackiness throughout microscopic strands comprising the filter medium 144. The nature of the cotton allows high volumes of airflow, and when combined with the tackiness of the filter oil composition creates a powerful filtering medium which ensures a high degree of air filtration.

During operation of the ventilation system 108, contaminant particles cling to the fibers within the volume of the filter medium 144 and become part of the filtering medium 144, a process referred to as “depth loading.” It will be appreciated that depth loading allows the cabin air filter 104 to capture and retain significantly more contaminants per unit of area than conventional cabin air filters. Contaminants collected on the surface of the cabin air filter 104 have little effect on air flow during much of the filter's service life because there are no small holes for the contaminants to clog. Contaminant particles are stopped by the layers of cotton gauze and held in suspension by the filter oil composition. Moreover, as the cabin air filter 104 collects an increasing volume of contaminants and debris, an additional form of filtering action begins to take place because the outside air must first pass through the trapped contaminants on the surface of the filter medium 144 before passing through deeper layers within the filter medium 144. In essence, the trapped contaminants begin to operate as a filter material which precedes the filter medium 144. Thus, the cabin air filter 104 continues to exhibit a high degree of air flow and filtration throughout the service life of the filter.

It is contemplated that treating the filter medium 144 with the filter oil composition generally enables the filter medium 144 to capture contaminants by way of interception, whereby contaminants, such as by way of non-limiting example, dirt particles, traveling with the air stream 124 directly contact the fibers comprising the filter medium 144 and are then held in place by the filter oil composition. Larger or heavier particles are generally captured by way of impaction, whereby the inertia or momentum of the particles causes them to deviate from the path of the air stream 124 through the filter medium 144, and instead the particles run straight into the fibers and are captured by the filter oil composition.

Particle contaminants having very small sizes may be captured by way of diffusion. Small particles have been found to be highly affected by forces within the air stream 124 through the filter medium 144. Forces due to velocity changes, pressure changes, and turbulence caused by other particles, as well as interaction with air molecules, generally causes the small particles to follow random, chaotic flow paths through the filter medium 144. Consequently, the small particles do not follow the air stream 124, and their erratic motion causes them to collide with the fibers comprising the filter medium 144 and remain captured by the filter oil composition. Diffusion and the filter oil composition enable the cabin air filter 104 to capture particle contaminants having sizes that are much smaller than the openings between the fibers comprising the filter medium 144. Furthermore, the filter oil composition enables the cabin air filter 104 to capture contaminants throughout the volume of the filter medium 144, rather than only on the surface of the filter as is common with conventional cabin air filters. The multiple layers of cotton fibers comprising the filter medium 144 coupled with the tackiness provided by the filter oil composition provide many levels of contaminant retention, thereby enabling the cabin air filter 104 to hold significantly more contaminants per unit of area of the filter medium 144 than is possible with conventional cabin air filters.

It is contemplated that the filter oil composition of the present disclosure is critical to the enhanced air flow and filtration properties of the cabin air filter 104. Preferably, the filter oil composition comprises an oil formulation which is non-reactive, has an excellent oxidation stability, possesses good thermal stability, and retains suitable viscosity at normal operating temperatures of the ventilation system 108. In some embodiments, the filter oil composition may be a mixture of oils and dyes (to provide color) suitable for enhancing the tackiness of the filter medium 144, such as by way of non-limiting example, paraffinic oils, polyalphaolefins (PAOs), and the like. In general, the filter oil composition comprises a mixture that includes paraffinic oil, PAO, and black dye. The paraffinic oil may range between 95.00% and 98.00% by volume of the mixture. The PAO may range between 1.00% and 4.00% by volume of the mixture, and the black dye may range between 0.04% and 1.00% by volume of the mixture. In one embodiment, the filter oil composition comprises a mixture of 96.74% paraffinic oil by volume, 3.20% PAO by volume, and 0.06% black dye by volume. In some embodiments, the filter oil composition has a viscosity at 100 degrees-C. ranging between substantially 7.2 and 7.6 centistokes (cSTs). It is to be understood that the particular oils and dyes, as well as their colors or viscosities, and their individual concentrations within the filter oil composition may be altered without deviating from the spirit and the scope of the present disclosure.

It should be understood that the filter oil composition of the present disclosure is not limited to being applied to the cabin air filter 104, but rather the filter oil composition of the present disclosure may be used with air filters configured for any enclosed space wherein passengers, drivers, as well as occupants reside, such as by way of non-limiting example, automobiles, trucks, recreational vehicles, buses, earthmoving equipment and tractors with enclosed cabins, crane operator cabins, various cargo moving vehicles, locomotives, rail passenger cars, airplanes, helicopters, ship cabins, airship cabins, and the like. Moreover, the filter oil composition of the present disclosure is not to be limited to air filters used in vehicles, but the filter oil composition may be applied to filters configured for use in buildings and detached residential homes. For example, the cabin air filter 104 may be incorporated into a heating, ventilation, and air conditioning (HVAC) system so as to clean interior air being circulated within, or outside air being drawn into, a building or a residential home. It should be understood, therefore, that the filter oil composition of the present disclosure may be used with air filters configured for use with rooftop HVAC systems, central HVAC systems, wall-mounted HVAC systems, as well as portable HVAC systems, and the like.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An air filter oil composition for causing tackiness throughout an air filter material to enhance airflow and filtration of air flowing through the air filter material, the composition comprising:
a first portion comprising paraffinic oil by volume of the composition;
a second portion comprising polyalphaolefin by volume of the composition; and
a third portion comprising black dye by volume of the composition.

2. The composition of claim 1, wherein the composition is substantially non-reactive, has an excellent oxidation stability, possesses good thermal stability, and retains a suitable viscosity within a temperature range typical of an operating automobile engine.

3. The composition of claim 1, wherein the composition has a viscosity at 100 degrees-C ranging between substantially 7.2 and 7.6 centistokes (cSTs).

4. The composition of claim 1, wherein the composition comprises paraffinic oil ranging between 95.00% and 98.00% by volume, polyalphaolefin ranging between 1.00% and 4.00% by volume, and black dye ranging between 0.04% and 1.00% by volume.

5. The composition of claim 4, wherein the composition comprises 96.74% paraffinic oil by volume, 3.20% polyalphaolefin by volume, and 0.06% black dye by volume.

6. The composition of claim 1, wherein the composition is configured to be applied to the air filter material by way of an aerosol spray.

7. The composition of claim 1, wherein the composition is configured to be applied to the air filter material by way of a squeeze bottle.

8. A method for an air filter oil composition for enhancing filtration of air flowing through an air filter material, the method comprising:
providing a first portion of paraffinic oil and a second portion of polyalphaolefin;
mixing the first portion with the second portion to form a mixture;
applying a third portion comprising black dye to the mixture to form a composition; and
configuring the composition to be applied to the air filter material.

9. The method of claim 8, wherein mixing includes providing the second portion such that the composition comprises polyalphaolefin ranging between 1.00% and 4.00% by volume.

10. The method of claim 9, wherein applying includes providing the third portion to the mixture such that the composition comprises black dye ranging between 0.04% and 1.00% by volume.

11. The method of claim 10, wherein applying includes providing the third portion to the mixture such that the composition comprises 96.74% paraffinic oil by volume, 3.20% polyalphaolefin by volume, and 0.06% black dye by volume.

12. The method of claim 8, wherein configuring includes configuring the composition to be applied to the air filter material by way of an aerosol spray.

13. The method of claim 8, wherein configuring includes configuring the composition to be applied to the air filter material by way of a squeeze bottle.

14. A method for enhanced filtration of an airstream, the method comprising:
configuring an air filter comprising a filter material that exhibits minimal resistance to the airstream;
formulating an air filter composition that causes tackiness throughout the filter material;
applying the air filter composition to the filter material; and
causing the airstream to flow through the filter material.

15. The method of claim 14, wherein formulating comprises:
providing a first portion of paraffinic oil and a second portion of polyalphaolefin;
mixing the first portion with the second portion to form a mixture;
applying a third portion comprising black dye to the mixture to form a composition; and
configuring the composition to be applied to the air filter material.

16. The method of claim 15, wherein applying includes providing the third portion to the mixture such that the composition comprises 96.74% paraffinic oil by volume, 3.20% polyalphaolefin by volume, and 0.06% black dye by volume.

17. The method of claim 14, wherein configuring includes sandwiching multiple layers of cotton gauze between two screens to form the filter material.

18. The method of claim 14, wherein applying includes using an aerosol spray to apply the air filter composition to the filter material.

19. The method of claim 14, wherein applying includes using a squeeze bottle to apply the air filter composition to the filter material.

20. The method of claim 14, wherein causing comprises positioning the air filter within a ventilation system which circulates air within an enclosed space.
